(19) United States
(12) Patent Application Publication
(10) Pub. No.: US 2005/0210393 A1
(43) Pub. Date: Sep. 22, 2005

(54) Asynchronous collaboration via audio/video annotation

(75) Inventor: Joon Maeng, Austin, TX (US)

Correspondence Address: RUBEN C. DELEON;WINSTEAD SECHROST & MINICK P.C., P.O. BOX 50784, DALLAS, TX, 75201, US

(73) Assignee: Forgent Networks, Inc., Austin, TX (US)

(21) Appl. No.: 11/129,962

(22) Filed: May 16, 2005

Related U.S. Application Data
(63) Continuation of application No. 09/609,609, filed on Jul. 5, 2000.

(51) Int. Cl. G06F 3/00; G06F 17/24; G11B 27/00; G06F 15/16; G06F 15/173

(52) U.S. Cl. 715/751; 715/759; 715/717; 715/719; 715/721; 715/733; 715/752; 715/753; 715/748; 715/512; 715/500.1; 715/716; 709/206; 709/242; 709/201; 709/204; 709/205; 709/217

(57) ABSTRACT

A system and method is disclosed for asynchronous collaboration between a plurality of remote users. More specifically, a system based on a client/server architecture is disclosed, in which a remote user may create a combined message having an audiovisual message and an image file on which collaboration is to occur. The remote user may then transmit the message and file to a central location, where it is stored and then accessed by other remote users for viewing, replying, and editing.

### CROSS-REFERENCE TO RELATED APPLICATION

This application is a continuation of prior application Ser. No. 09/609,609, filed on Jul. 5, 2000, entitled ASYNCHRONOUS COLLABORATION VIA AUDIO/VIDEO ANNOTATION, by inventor Joon Maeng.

### FIELD OF THE INVENTION

The present invention relates to the field of electronic communication and more specifically to communication of annotated audiovisual information to and from remote users.

### DESCRIPTION OF THE RELATED ART

A significant development in computer networking is the Internet, which is a sophisticated worldwide network of computer systems. There are several different types of information that may be communicated via the Internet or other computer network, including video mail, electronic mail, and web pages, which may be made up of various types of content and presentation formats.

One of the benefits of electronic communication, such as electronic mail (e-mail) is that a user may attach files to a message. These files may include documents, web pages, and the like. One drawback to the provision of such files is that the files must be sent as an attachment to an e-mail, and cannot be edited directly, that is, text notes or other information relating to the file must be sent as an attachment.

A benefit of a computer network is that a plurality of remote entities or users may communicate quickly and efficiently. Further, a group of such users may collaborate on a project remotely. For example, one user may create an electronic textual file by use of any known word processing application program, and then e-mail the file as an attachment to the message. Then, the other users can provide comments, and send a revised file back to the original sender. However, this process leads to inefficiencies.

### SUMMARY OF THE INVENTION

In accordance with the present invention, a system is provided to allow remote entities to asynchronously collaborate with regard to a desired file. More particularly, the present invention permits a user to create an audiovisual message and deliver it as a combined file with the desired file. As used herein, the term “v-mail,” “video mail” or “audiovisual message” means an electronic file containing at least audio and video information and may also include textual and/or graphical information. The message may then be delivered directly to recipients via a standard e-mail or v-mail program, or the message may be provided to a central location, which provides for management, control and delivery of the message to the selected recipients.

In one embodiment, the present invention includes method of asynchronous communication by a plurality of users via a computer network, including the steps of selecting a file and capturing it as an image file; creating an audiovisual message relating to the file; appending the image file and the audiovisual message to achieve a combined message; and electronically delivering it to at least one of the users.

Further, the present invention includes a method of transmitting a concatenated audiovisual file via a computer network, including the steps of locating a first audiovisual file having a first identification code and a plurality of frames; locating a second audiovisual file having the first identification code, a first frame reference number, and a first reply portion; transmitting at least a portion of the first audiovisual file via the network until the first frame reference number is attained; and transmitting the first reply portion after the first portion.

Additionally, an embodiment of the present invention includes a system for the creation and delivery of an audiovisual message, including remote workstations adapted to permit a client to capture selected content, annotate the content, create an audiovisual message, combine the content, annotation, and audiovisual message as a linked message, and deliver it to at least one remote recipient; a central server connected to the remote workstations, and being adapted to receive the linked message and to receive at least one reply message; and a central storage location having a relational index to correlate reply messages to the linked messages.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a block diagram of an example of a computerized information network in accordance with the present invention.

FIG. 2 is a representation of an example graphical user interface that may be used in one embodiment of the present invention.

FIG. 3 is a block diagram of an example screen display of a message in accordance with the present invention.

FIG. 4 is a block diagram of an example network that may be used in accordance with the present invention.

FIG. 5A is a block diagram of an example embodiment of a file format of a video message in accordance with the present invention.

FIG. 5B is a block diagram of an example embodiment of a file format of a reply to a video message in accordance with the present invention.

FIG. 5C is a block diagram of an example embodiment of a file format of a video message in accordance with the present invention, showing the location of preselected frames.

### DETAILED DESCRIPTION OF THE INVENTION

While the Internet is used herein as an example of how the present invention is utilized, it is important to recognize that the present invention is also applicable to other electronic communication applications, such as video teleconferencing, computerized information networks, and the like. A brief overview of concepts pertaining to the Internet, the world-wide web, and web servers is presented to introduce terminology used throughout the description and claims of the present invention.

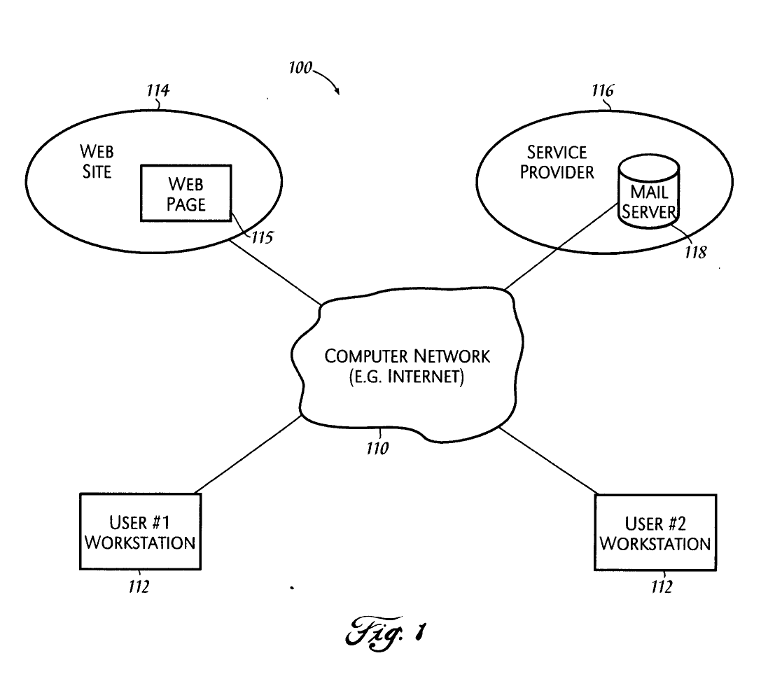

An example of a typical connection of components in an electronic network 100, such as the Internet, is shown in FIG. 1. A user that wishes to access information via the electronic network 100 may communicate through a computer network 110, such as the Internet. The user typically uses a client workstation 112 that executes application programs, such as a browser and an electronic mail program, for example. Of course, a plurality of workstations 112 may be interconnected so that plural users may communicate. Workstations 112 may be connected via any one of numerous communications links, such as a dial-up wired connection with a modem, a direct link such as a Tl, ISDN, or cable line, a wireless connection through a cellular or satellite network, or a local data transport system such as Ethernet or token ring over a local area network.

As shown in FIG. 1, a user may use client workstation 112, which may be a personal computer, Internet appliance, personal digital assistant, or the like, to access remote content, such as a web site 114. In an example embodiment, the web site 114 may contain content including audio and visual information. Further, the web site 114 may be arranged as a group of web pages 115, each relating to a particular subject or the like. It is to be understood that the web site and web page may be resident on a remote server computer, as is well known in the art. A web page is primarily visual data that is intended to be displayed on a display device, such as the monitor of user workstation 112. When a web page request is received, a document, generally written in a markup language such as hypertext markup language (HTML) is transmitted across the communication link to the requesting browser. The browser interprets the markup language and outputs the web page to the monitor of user workstation 112. This web page displayed on the user's display may contain text, graphics, and links (which are addresses of other web pages). The user can go to these other web pages by clicking on the links using a mouse or other pointing device. This entire system of web pages with links to other web pages on other servers across the world is known as the “World Wide Web”.

A user may also access information located at a remote location of a service provider 116 via the network 110. For example, the user may desire to access a mail server 118 located at the service provider 116, in order to obtain access to electronic mail, video mail, or the like.

The preceding discussion relates to well known features and components used in typical computing environments, and more particularly for use in a computer network. One benefit of such a computer network is that a plurality of remote entities or users may communicate quickly and efficiently. Further, a group of such users may collaborate on a project remotely. As discussed above, a user may create a text file and e-mail the file as an attachment to the message. Then, other users can provide comments, and send a revised file back to the original sender. However, this process leads to inefficiencies. Accordingly, the system disclosed herein allows remote users to collaborate asynchronously, by allowing users to send and receive audiovisual messages which may themselves include comments regarding an associated file.

In one example of the present invention, a user may desire to provide annotation to a file which it seeks to provide to one or more recipients. For example, a user may wish to send a web page to co-workers. Further, the user may wish to send the web page with annotation, such as editing, markup, or highlighting of the web page, and also include an audiovisual message, or a combination thereof. Upon receipt of such a combined message, one or more of the co-workers may similarly annotate the message, create an audiovisual reply and forward the reply to some or all of the original recipients. In this way, a user may thus collaborate asynchronously with the recipient(s) of the message.

In a more particular embodiment, a user may create a combined message to send to one or more users via a computer network. Specifically, the user may capture content of a particular file (such as a web page, document, or the like) into an image file, then add annotation to the image file (such as text, highlighting, editing, commenting, or the like), then add an audiovisual mail message to the image file, and send the combined message to the selected user or users. In addition, the recipient(s) may also add annotation and provide an audiovisual message in response. In certain embodiments, the recipient may provide a reply with an attached address pointer, indicating a preselected point in the original message at which the reply should be played, so that the amount of data included in the reply may be reduced.

To create a combined message, the user may access a graphical user interface (GUI) which provides access to the annotation and audiovisual features of the present invention, and which may be a WINDOWS-based software module. Further, such a GUI may be implemented as an ActiveX control embedded within a web page or the like. Alternately, a Java Media Framework-based applet, a standalone client application, or a NETSCAPE plugin may be used to access the software of the system. In example embodiments, a user may access the GUI at a client workstation or the like via a screen icon, hot key, pull-down menu, or in any other manner.

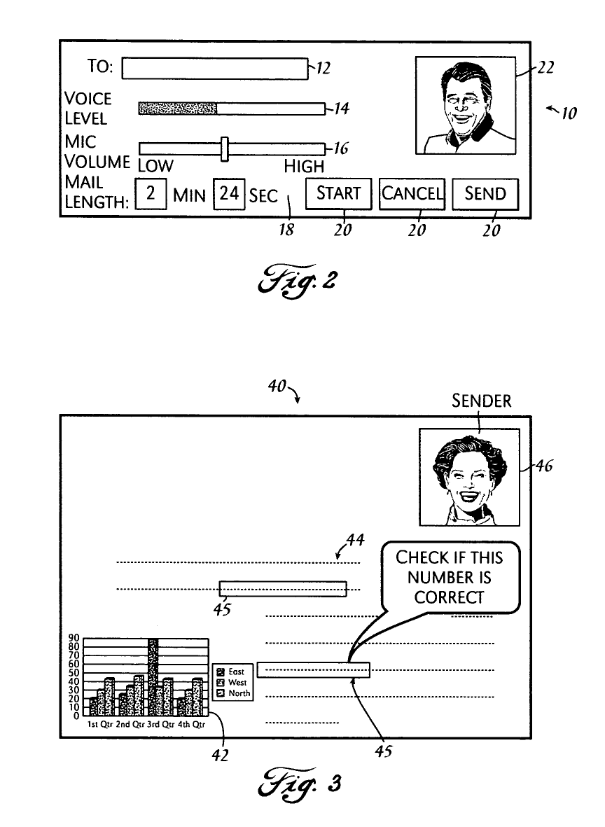

FIG. 2 is an example embodiment of a GUI 10 for use in connection with the creation of video messages. As shown in FIG. 2, the GUI may contain a “To” field 12, so that the user can enter the address of intended recipient(s). Addresses may be obtained via a preexisting address book, such as available in MICROSOFT OUTLOOK. Further, it is to be understood that other fields not shown in FIG. 2, such as “CC” and “BCC” may be present in certain embodiments. Additionally, a “subject” field and a field for inserting text may also be present in certain embodiments. In certain embodiments, voice recognition may be used so that the user may simply speak the names of the intended recipients, and the recognition software will select the recipients from a list.

Also shown in FIG. 2, the GUI 10 may contain a voice level indicator 14, a microphone volume selector 16, a mail length indicator 18, video window 22, and a plurality of stateful buttons 20. The microphone volume selector 16 may be controlled via a cursor or the like to control the sensitivity of the microphone input. However, it is to be understood that in other embodiments, the sensitivity may be automatically controlled by an automatic gain controller (AGC), and that the voice level indicator 14 and the microphone volume selector 16 may be hidden. The video window 22 may actively display the view of a video camera or other capture device connected to the computer, so that the user may see and adjust his or her image. It is to be understood that in example embodiments, a GUI may contain more or fewer indicators, fields, and the like.

In an example embodiment, a user may utilize capture devices connected to his or her workstation to record the audiovisual information and transform it into a digital format. These capture devices may include a camera device having a composite video output, such as available from Sony Corporation, or a USB camera, an example of which is available from Intel Corp. (Santa Clara, Calif.). Further, a microphone connected to the computer may be used to capture audio. In an example embodiment, a user's default capture devices as specified in the WINDOWS Multimedia control panel may be used. In an example embodiment, the capture bandwidth may be set at 56 KB/sec. using H.263 to encode video and GSM (for example, G.728 or G.723.1 protocols) to encode audio. However, it is to be understood that other bandwidths and protocols may be used, such as higher 128 KB/sec. or 384 KB/sec. bandwidths, and MPEG encoding of video.

Additionally, it is to be understood that each user's workstation may have appropriate audiovisual playback equipment, in addition to capture devices. This equipment may include a video monitor, audio speakers, and the like. Further, the workstations may have appropriate audio and video encoders and decoders, as is well known in the art, and described in U.S. Pat. No. 6,014,689, the disclosure of which is hereby expressly incorporated by reference.

Further, in example embodiments, the audio and image data may be compressed using a variety of distinctly different compression schemes to save storage space, as known in the art. The data may also be encrypted to help prevent unauthorized access to the data. Well known application programs may be used to compress, decompress, encrypt, and decrypt data, as required.

In operation, the user may perform desired tasks using the stateful buttons 20, which are graphical representations of functions available, and which may be selected by clicking a mouse, key, or other pointing device. In an example embodiment, a first state may exist that includes three stateful buttons 20, namely a “Start-A/V Only,” a “Start Recording,” and an “Exit” button. When the user selects the “Start-A/V Only” button, recording is begun to create a message without any attachment. Selection of the “Start” button begins recording, and includes a selected file for attachment to the message. When the user selects either of the start buttons, the state changes to a second state.

In the second state, a “Pause,” “Cancel,” and “Send” button may appear on the GUI. The “Pause” button may be used to pause recording, the “Cancel” button terminates the recording without saving the message, and the “Send” button sends the message to the preselected recipients. When the “Pause” button is selected, a third state may be entered in which four new buttons may appear on the GUI. Specifically, these buttons may include a “Resume,” a “Cancel,” an “Exit,” and a “Send” button. The “Resume” button continues the recording from the position where it was paused, and control returns to the second state. The “Cancel” button, in any state, returns control to the first state. Further, the “Exit” button is used to exit the GUI. It is to be understood that in other embodiments, there may be more, fewer, or different functions and states available. For example, a preview function may be made available to permit a user to preview a recorded message before sending it. Further, a GUI having similar functions may be used to provide a user with various playback options, including allowing a user to periodically pause playback in order to create an audiovisual reply.

In example embodiments, when the “Start” button is selected, a cursor on a video screen may change into a highlighter or other markup device, so that the user may highlight or otherwise markup portions of the file to be appended to the message. Upon activating the highlighter, the user may use a mouse or other pointing device to control movement of the highlighter, with the left mouse button (or the like) being used to start/stop highlighting, while the mouse is dragged to highlight the selected material. Additionally, upon entry into the GUI, the selected file may be activated to allow the user to edit or otherwise modify the file using well known tools such as are available in a word processing or other application program.

FIG. 3 is an example embodiment of a video display of a combined message, as viewed by a recipient. As shown in FIG. 3, the display 40 includes an image file 42, an annotation of text information 44 including highlighted portions 45, and a video inset 46, which may be played by the recipient to view an audiovisual message forwarded by the sender. As shown in FIG. 3, the combined message appears as an integrated image; that is, there is no attachment to the message, instead the message is a single cohesive display. Although shown having an image file, annotation, and an audiovisual message, it is to be understood that in certain embodiments, one or more of these fields may not be desired.

It is to be understood that delivery of audiovisual messages may be accomplished via standard electronic mail programs and the like. In an example embodiment, however, a system may be provided via a computer network having a client/server architecture, wherein the created messages are provided from remote client sites to a central server for management, storage and delivery. Such a central server site may be an application service provider (“ASP”) or may be internal to a given company or entity.

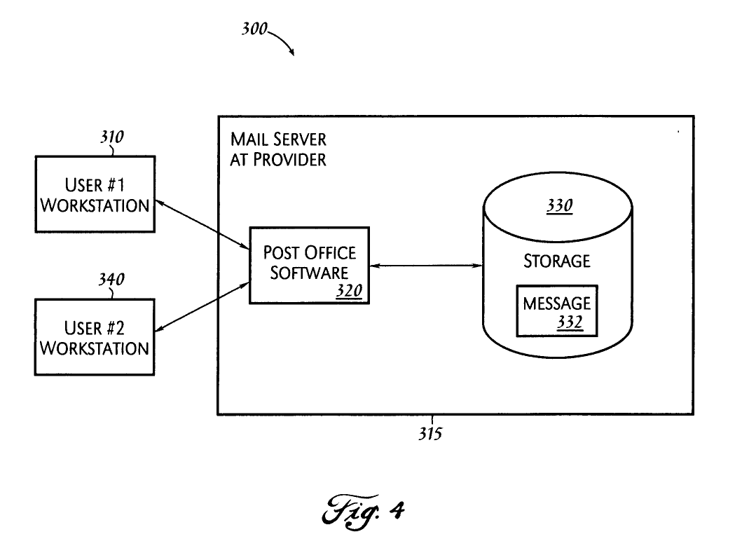

FIG. 4 is a block diagram of an example client/server system 300. As shown in FIG. 4, the system 300 includes a remote client site 310 (of course, a plurality of such sites may be present in a given embodiment), which in an example embodiment may be a workstation such as a personal computer, Internet appliance, personal digital assistant (“PDA”), or the like. The remote client site 310 is interconnected to a central server 315 of a provider or the like via a desired computer network, such as the Internet. The central server 315 may be a standard server computer operating on a WINDOWS, UNIX, or LINUX platform, such as an IBM RS/6000, AS/400, DELL POWEREDGE, or the like. The central server 315 may include post office software 320, which may act as a central interface for the system, and be responsible for the managing of messages, and control of access to the same.

Additionally, as shown in FIG. 4, the system may include a storage center 330 for the storage of messages 332. In an example embodiment, the storage center 330 may be part of the central server 315, or may be an external mass memory storage, such as a storage area network (SAN), such as a DELL POWERVAULT, or the like. Additionally shown in FIG. 4 is a remote recipient site 340, which may be a workstation, such as a personal computer, Internet appliance, PDA, or the like. Of course, in example embodiments a plurality of client sites 310 and a plurality of recipient sites 340 may be present. In sum, the system may be thought of as a plurality of Clients 310 and/or 340 connected to a Post Office 320, which in turn is connected to a Storage Center 330. In an example embodiment, the storage center 330 may make use of a relational database management system using an index system to provide safe, efficient control of the messages.

In an example embodiment, the post office software 320 may provide for storage of in-transit messages, and be responsible for generating notification messages when a new message for a particular recipient arrives. Additionally, the post office software 320 may act as a media server from which streaming playback may occur to provide a recipient with audiovisual data. Upon receipt of a new video mail message, the software 320 may send electronic mail messages to recipients that contain a clickable Uniform Resource Locator (URL) which provides a hyperlinked address so the recipient may access the message in the Storage Center 330.

Upon receiving an access request from a recipient, the central server 315 accesses the appropriate message from the storage center 330, and delivers it (via the Internet or other computer network). In an example embodiment, the message may be streamed to the recipient(s). Recipients may play back messages using a viewer applet, such as the Vviewer applet available from VTEL Corp. (Austin, Tex.) as part of the TURBOCAST suite of products. Use of such an applet obviates the need to download and install helper applications or plugins. Alternately, other known viewers, such as MICROSOFT MEDIA PLAYER, REAL PLAYER, or an applet viewer with the message attached may be used. By streaming the video to a recipient, there is no need to include large video files within messages. The applet may permit a recipient to perform simple play/pause functionality, and the ability to seek backwards and forwards within the message.

As discussed above, a recipient may reply to a message with audiovisual material, using the same general techniques described above for creating a message. As with a standard e-mail reply, which is sent with the original message, the reply message may be sent with the original message attached. However, in certain embodiments, the recipient may choose to have the reply concatenated onto the message, so that when viewed, reply portions will appear at a preselected point in the message. For example, a message may contain a discussion of three topics. A reply to the message may also contain a discussion of each of the topics. Using the present invention, a recipient may develop its reply to correspond and concatenate it to each of the topics.

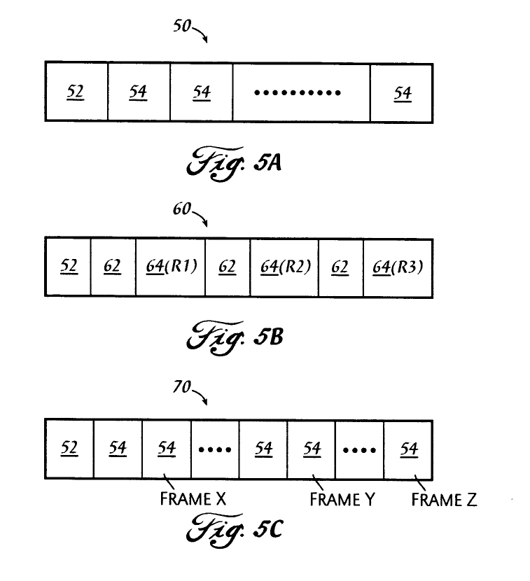

Shown in FIG. 5A is a block diagram representation of a video file or record format. As shown in FIG. 5A, a video file 50 includes a file identification code 52 and a plurality of bytes 54 containing digital representations of information (i.e., video, audio, text, or a combination thereof).

In operation, video data is viewed by a recipient at 30 frames per second, as is standard. When a recipient wishes to respond at a certain point in the streaming video message, he or she can access a GUI, as discussed above, and use the stateful buttons to create a reply. In an example embodiment, playback of the message will be paused while the recipient creates a reply. At the start of the reply process, the GUI will store a file identification code corresponding to the message being played, and a frame reference number, which is the point in the video playback at which the recipient wishes to reply.

Upon completion of a reply portion, the recipient may continue viewing the message, and may use the GUI to again stop the message at a particular position, so that another reply portion to some other portion of the message may be created. This process may be performed iteratively. At the conclusion of the message, a recipient may have a reply message that contains a plurality of reply portions. As discussed above, each of these reply portions may have a corresponding file identification code and a frame reference number associated with it. In this way, the completed reply message may be sent without the original message to reduce file size.

The recipient may then send the completed reply message to a list of individuals, including the author of the original message, other recipients, or other interested individuals. In an example embodiment, the reply message may be provided to central server 315, which will perform the management functions. These functions may include advising recipients of the reply that it is available for viewing (for example, via e-mail with a URL hyperlink). Additionally, the post office software 320 will provide the reply message to the Storage Center 330. Using the relational database architecture of the Storage Center 330, the reply will be stored so that it may be accessed in conjunction with the original message. Of course it is to be understood that the reply message may be viewed by its recipients independently of the original message, at the conclusion of the message.

FIG. 5B shows a reply message 60 that contains three independent reply portions, R1, R2, and R3, each of which corresponds to a different portion of the original message. As shown in FIG. 5B, the reply message 60 contains a file identification code 52 (which will be identical to the identification code of the original message to which it is responding), frame reference numbers 62, and reply portions 64. The frame reference numbers 62 correspond to the point (or “preselected frame”) in the original message at which a reply was initiated. FIG. 5C shows the preselected frames (shown as “Frame X,” “Frame Y,” and “Frame Z”) of the original message 50 after which the reply portions will be shown.

In operation, when a recipient desires to see a combined message, i.e., the original message with concatenated replies, which may be selected from an appropriate button on a viewer GUI, the appropriate files will be accessed via the Storage Center 330. For example, as shown in FIG. 5C, the system displays a message 70, which includes the original message 50 and any replies having the file identification code of the original message. Then, the system will show the original message 50, until a preselected frame (e.g., “Frame X”), which corresponds to the frame identification where the first reply portion R1 was initiated, is reached. Then, R1 of reply message 60 will be played, as it is stored with a frame reference number 62 corresponding to the preselected frame. At the conclusion of the R1 portion, the original message 50 will continue, until another preselected frame (e.g., “Frame Y”) corresponding to another reply portion (e.g., R2) of reply message 60 is reached. In this manner, the system provides for asynchronous collaboration, so that a recipient may view an original message and replies thereto as a cohesive and concatenated message. Further, it is to be understood that a plurality of replies from a plurality of users may be concatenated in accordance with the above.

### Other Embodiments

While the invention has been described with respect to the embodiments and variations set forth above, these embodiments and variations are illustrative and the invention is not to be considered limited in scope to these embodiments and variations. For example, the invention may be provided via software encompassing any computer readable medium, such as CD-ROM, diskette, ZIP disk, tapes, ROM, RAM, hard drive and the like. Accordingly, various other embodiments and modifications and improvements not described herein may be within the spirit and scope of the present invention, as defined by the following claims.

1. A method of asynchronous communication by a plurality of users via a network of interconnected computers, comprising:
selecting, at a client site, a file and capturing the file as an image file;
annotating at least one portion of the image file, wherein annotating is selected from the group consisting of editing, mark-up, commenting and highlighting;
creating, at least at the client site, an audiovisual message, the audiovisual message relating to the annotated image file, wherein creating comprises capturing digital information;
appending the annotated image file and the audiovisual message, whereby an annotated combined message results therefrom; and
electronically delivering via the computer network the annotated combined message to at least one of the plurality of users.

2. The method of claim 1, wherein the step of electronically delivering comprises streaming the digital information via the network.

3. The method of claim 1, further comprising creating a reply record, the reply record having audiovisual material, the reply record being in response to the annotated combined message.

4. The method of claim 3, wherein the reply record is created by one of the plurality of users, and further wherein the one of the plurality of users annotates the annotated image file.

5. The method of claim 1, wherein the annotation of at least one portion of the image file is accomplished by way of a cursor-based highlighter.

6. The method of claim 1, wherein the creating comprises accessing a user interface, the user interface having stateful buttons.

7. The method of claim 1, wherein the step of selecting further comprises activating the image file for editing.

8. The method of claim 1, wherein the electronically delivering comprises transmitting the annotated combined message to a central server for storage and further transmission.

9. A method of asynchronous communication by creating and delivering an electronic audiovisual message between a plurality of users over a network of interconnected computers, comprising:
selecting, at a client site, a file and capturing at least a portion of an electronic document as an image file;
annotating at least one portion of the image file, wherein annotating is selected from the group consisting of editing, mark-up, commenting and highlighting;
creating an electronic audiovisual message by capturing, at least at the client site, digital information via at least a plurality of capture devices comprising a camera device and audiovisual playback equipment connected to a computer workstation, wherein the electronic audiovisual message relates to the annotated image file;
appending the annotated image file and the audiovisual message, wherein a graphical user interface (GUI) is utilized to assist in creating and appending the electronic audiovisual message and annotated image file, whereby an annotated combined message results therefrom; and
electronically delivering via the computer network the annotated combined message to at least one of the plurality of users.

10. The method of claim 9 wherein the audiovisual playback equipment comprises a video monitor and audio speakers.

11. The method of claim 9 wherein the computer workstation comprises audio encoders, video encoders, audio decoders and video decoders.

12. The method of claim 9 wherein the audio and image data is compressed utilizing a plurality of compression schemes to save storage space.

13. The method of claim 9 wherein the data is encrypted to prevent unauthorized access to the data.

14. The method of claim 12 wherein the data is encrypted to prevent unauthorized access to the data.

15. The method of claim 9 wherein the GUI comprises a first, second and third state, wherein each of the first, second and third states comprise a plurality of stateful buttons, wherein the buttons are graphical representations of a plurality of functions available via a selection device.

16. A method of creating and delivering an electronic audiovisual message via a network of computing means, comprising:
capturing at least a portion of an electronic document as an image file;
annotating the image file, wherein annotating is selected from the group consisting of editing, mark-up, commenting and highlighting;
creating the electronic audiovisual message, the electronic audiovisual message regarding the annotation of the image file;
combining the annotated image file and the electronic audiovisual message into an annotated combined message; and
delivering the annotated combined message to at least one desired recipient via the network.

17. The method of claim 16, further comprising replying to the annotated combined message via the network, wherein the replying comprises creating an audiovisual reply designated for insertion at a predetermined point in the annotated combined message.

18. The method of claim 17, wherein the step of replying comprises delivering the audiovisual reply with an address pointer indicative of the predetermined point.

19. The method of claim 16, wherein the step of delivering comprises storing the annotated combined message at a remote location and sending an electronic notification having, a uniform resource locator corresponding to the location.

20. The method of claim 16, wherein the step of delivering comprises streaming the annotated combined message to the at least one desired recipient via the Internet.

21. A machine-readable storage medium comprising a set of instructions executable by a computer system to implement a method, the method comprising:
providing a graphical user interface to allow a user to select desired content as an image file;
permitting the user to annotate the image file with an annotation, wherein the annotation is selected from the group consisting of editing, mark-up, commenting and highlighting;
capturing audiovisual material responsive to the annotated image file as a digital file;
pairing the digital file and the annotated image file as an annotated combined file; and
delivering the annotated combined file to at least one desired location via the computer system.

22. The computer program product of claim 21, wherein the machine-readable storage medium comprises any of magnetic storage medium selected from the group consisting of disk and tape storage medium; optical storage medium, comprising compact disk memory and digital video disk storage medium; nonvolatile memory storage memory; volatile storage medium; and modulated, electronic signals.
